(19) United States
(12) Patent Application Publication
(10) Pub. No.: US 2003/0179737 A1
(43) Pub. Date: Sep. 25, 2003

(54) Processing non-pilot channels in a CDMA searcher

(76) Inventors: Avner Dor, Kiriat Ono (IL); Daniel Yellin, Raanana (IL)

Correspondence Address: FISH & RICHARDSON, PC, 4350 LA JOLLA VILLAGE DRIVE, SUITE 500, SAN DIEGO, CA, 92122, US

(21) Appl. No.: 10/107,527

(22) Filed: Mar. 25, 2002

(51) Int. Cl. H04B 7/216; H04J 3/06; H04B 15/00

(52) U.S. Cl. 370/342; 370/350; 370/503; 455/502

(57) ABSTRACT

Synchronization in a CDMA system includes processing at least one non-pilot channel and determining whether a base station is synchronized based on the results of processing.

### BACKGROUND

This invention relates to processing non-pilot channels in a code division multiple access (CDMA) searcher.

CDMA communication technologies can be utilized in wireless communications systems such as cellular telephone systems. The system can include base stations that communicate with mobile stations over traffic channels using the same frequency. In such a system, each mobile station is assigned a spreading-sequence (a line of a n×n Walsh matrix in a contemporary CDMA network(n=64,128,256)) and a scrambling sequence (a long pseudorandom or gold sequence that is local to the base or to the network in present CDMA networks) which are used to spread the sequence of incoming signals, filtered to an assigned bandwidth in order to recover transmitted information. Each base station transmits, in addition, a pilot channel (currently transmitting the base scrambling sequence with no information), which is received by all local mobile stations. Each network base station of the same location uses the same pilot code but with a different time offset to enable each mobile state to distinguish the signals transmitted from different base stations.

In order for the mobile station to use a traffic channel and communicate through the communications network, the mobile station needs to synchronize on a time scale with a nearby base station using the pilot channel. Generally, a searcher receiver in each mobile station attempts to synchronize with a base station by correlating a scrambling sequence generated by the mobile station with a sequence of incoming sampled signals.

### BRIEF DESCRIPTION OF THE DRAWINGS

FIG. 1 is a block diagram of a communications system.

FIG. 2 is block diagram of a searcher receiver.

FIG. 3 is flow diagram of a method of operating the searcher receiver according.

### DETAILED DESCRIPTION

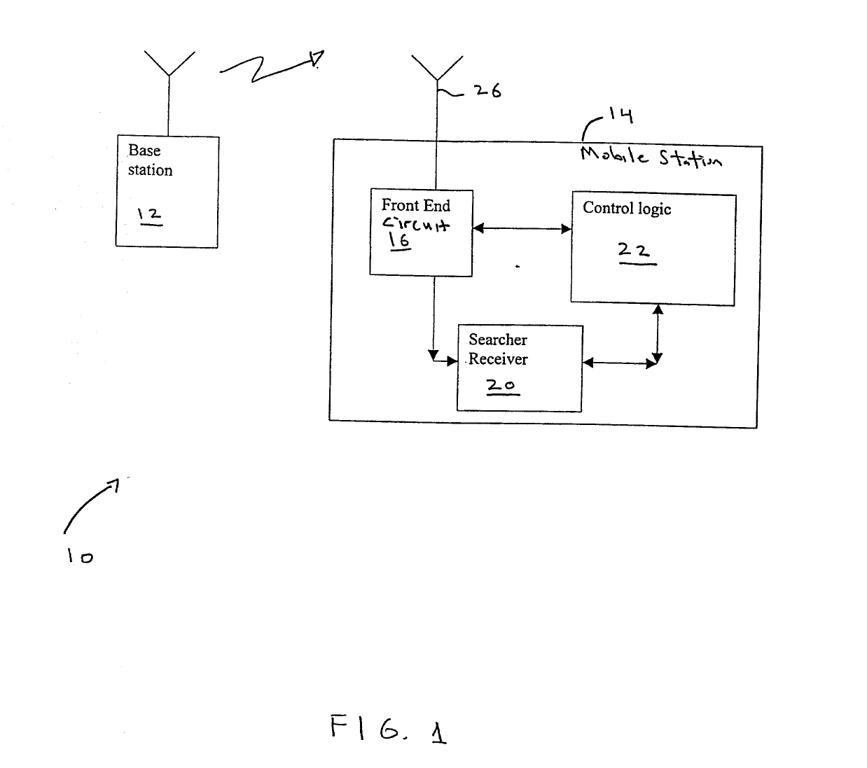

As shown in FIG. 1, a communications system 10 includes base stations, such as base station 12, configured for radio communications with one or more mobile stations such as mobile station 14. The mobile station 14 is configured to transmit and receive information in a CDMA network and hence it can communicate with the base station 12.

The base station 12 transmits signals containing data to the mobile station 14. In a CDMA embodiment, the base station 12 uses a spread spectrum technique for transmitting data that occupies a larger bandwidth than what is commonly required for conventional techniques. This technique employs a code-sequence, which is independent of the data, to modulate the data to be transmitted. The conjugate of this code is used to demodulate the data at a receiving end. The data on a traffic channel is spread using a spread code such as an orthogonal Walsh code in a process known as Walsh covering. Each base station assigns a unique orthogonal Walsh code to each mobile station.

The use of a Walsh code allows the symbols transmitted to each mobile station to be orthogonal with respect to every other mobile station. Each mobile station processes the sequence of sampled-incoming-signals with its own assigned Walsh code that corresponds with its assigned traffic channel and with the local scrambling sequence.

In addition to traffic channels, the base station 12 broadcasts a pilot channel, a synchronization channel, and a paging channel (or channels). The pilot channel is formed by transmitting an all-zero data sequence covered by Walsh code 0 consisting of all 1's. The pilot channel can be received by all mobile stations within range and is used by a mobile station for identifying the presence of a CDMA base-station, initial system acquisition, idle mode handoff, and for demodulation of the synchronization, paging, and traffic channels. The synchronization channel is used for synchronizing mobile station to base station timing. The paging channel is used for sending paging information from the base station 12 to the mobile stations including mobile station 14.

In addition to Walsh covering, the channels transmitted by the base station are spread using a scrambling sequence such as a pseudorandom noise (PN) sequence or gold sequence, also referred to as the pilot sequence. Each base station 12 in the communications system 10 is uniquely identified by using a starting phase, also referred to as a starting time, phase shift or time offset, for the scrambling sequence. The spread pilot channel modulates a radio frequency (RF) carrier and is transmitted to the mobile stations in a geographic area served by the base station 12. The scrambling sequence can be complex including both in-phase (I) and quadrature (Q) components. Consequently, all processing of the pilot signal described below may involve both I and Q components.

The mobile station 14 includes an antenna 26, a front-end circuit 16, a searcher receiver 20, and control logic 22. The antenna 26 receives RF signals from the base station 12 and from other base stations in the vicinity.

Received RF signals are converted by the antenna 26 to electrical signals which are forwarded to the front-end circuit 16. The front-end circuit 16 filters and converts the electrical signals into a stream of digital data for further processing by the searcher receiver 20.

The searcher receiver 20 detects pilot signals received by the mobile station 14 from the base stations such as the base station 12. The searcher receiver 20 stores the stream of digital data containing a pilot signal and non-pilot signals into a buffer organized into groups of data called symbols. The searcher receiver 20 produces correlated symbols by correlating the input symbols with local scrambling sequences (currently PN or gold) and spreading sequences (currently Walsh).

After producing the correlated symbols, the searcher receiver 20 performs a probability computation using the correlated symbols. The probability computed is based on an event that a selected time offset which is under consideration that approximates the time difference between the mobile clock and the base clock (or the complement of this event). If the computed probability does not satisfy predetermined thresholds, the process is repeated using new samples from the buffer. If a false-alarm threshold is satisfied, the mobile station 14 can use the selected time offset to synchronize with the base station 14 and subsequently communicate with it.

The front-end circuit 16 also is capable of converting electrical signals generated by control logic 22 into RF signals which subsequently can be transmitted from the mobile station 14 to the base station 12. The control logic 22 includes memory elements and processing logic for controlling the operation of the mobile station 14.

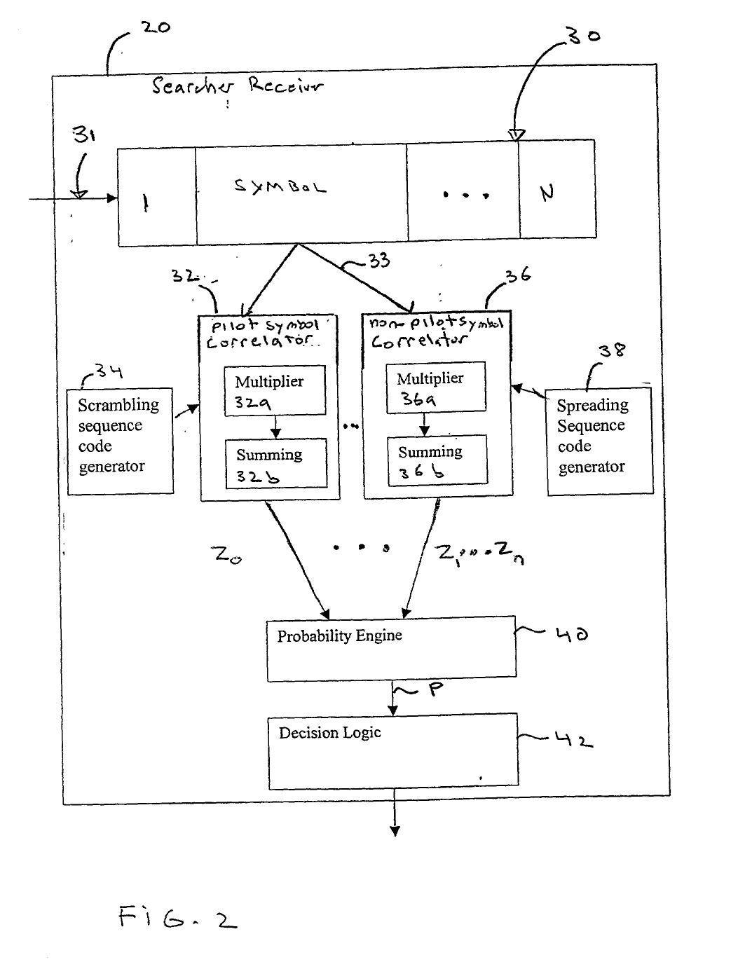

As shown in FIG. 2, the searcher receiver 20 includes a buffer 30, a pilot symbol correlator 32 and corresponding scrambling sequence code generator 34. The receiver 20 also includes one or more non-pilot symbol correlators 36 and corresponding spreading sequence code generators 38. A probability engine 40 and decision logic 42 also are part of the searcher receiver 20.

The searcher receiver 20 detects pilot signals to acquire system timing for synchronizing the mobile station 14 with the base station 12. The searcher receiver 20 samples the input signals received from the front-end circuit 16 at a certain sampling rate and sends the resulting samples into the input side 31 of the buffer 30. The sampling can be performed by an analog to digital (A/D) converter coupled to the input side 31 of the buffer 30. The buffer 30 then stores the sampled signals as units called symbols. Each symbol can be a multiple of the power two, such as, 32, 64, 128, 256. The number of symbols that the buffer 30 can store varies from 1 to N symbols depending on design criteria such as cost and performance tradeoffs.

Each symbol contains a number of chips (64 in CDMA IS-95 128 in CDMA 2000 and 256 in Wide Band (WB) CDMA) where each chip is the time period that reflects the frequency used in a given CDMA system. In one embodiment, the buffer 30 has a storage capacity of 36 network symbols, sampled once or twice per chip. For example, the storage in a WB-CDMA system is approximately 256×36=9216 samples or twice this amount if the sampling is done twice per chip.

Such a CDMA system can include a direct sequence CDMA (DS-CDMA) system as defined, for example, in Telecommunications Industry Association (TIA/EIA) Interim standard IS-95, “Mobile Station-Base-Station Compatibility Standard for Dual-Mode Wideband Spread Spectrum Cellular System” (IS-95). In such a DS-CDMA system, each sequence has a length of 256 chips which are produced at a chip rate of 1.2288 Mega-chips per second and that repeats every 26 ⅔ milliseconds. The minimum time separations are 64 chips in length allowing a total of 512 different PN code phase assignments for the base stations.

The pilot symbol correlator 32 is coupled to the output 33 of the buffer 30 and is able to retrieve data samples in groups such as symbols from the buffer. The pilot symbol correlator 32 can include standard digital signal processing elements such as a multiplier element 32a and a summing element 32b. The multiplier element 32a produces a product result by multiplying each sample from the symbol with a scrambling sequence code generated by the scrambling sequence code generator 34. The scrambling sequence code generator 34 generates an array of scrambling sequence codes indexed by a range of time offsets which are used during the calculations. Each of the time offsets represent an estimate of the time offset associated with the pilot signal. The summing element 32b accumulates each product result from the multiplication calculation to produce a correlated pilot symbol z₀.

Similarly, the non-pilot symbol correlator 36 is coupled to the output 33 of the buffer 30 and is able to retrieve data samples in groups such as symbols from the buffer. The correlator 36 also can include standard components such as a multiplier element 36a and a summing element 36b. The multiplier element 36a produces a product result by multiplying each sample in the symbol with a spreading sequence code generated by the spreading sequence code generator 38. The spreading sequence code generator 38 generates an array of spreading sequence codes indexed by a range of time offsets, which are used during the calculations. Each time offset represents an estimate of the time offset associated with the pilot signal. The summing element 36b accumulates each product result to produce a correlated non-pilot symbol z₁. Although only one correlator 36 is discussed above, the searcher receiver 20 can include multiple non-pilot correlators each of which is capable of producing correlated non-pilot symbols (z₁ to zₙ).

The probability engine is 40 coupled to the output of the pilot symbol correlator 32 and to the output of the non-pilot symbol correlators 36. The probability engine 40 includes logic for calculating a probability P using the correlated pilot symbol Z0 and the correlated non-pilot symbols such as z₁, to zₙ. The probability P is an assumption or hypothesis that the selected time offset approximates a time offset associated with the pilot signal.

The decision logic module 42 is coupled to an output of the probability engine 40 for calculating the probability P produced by the engine. The probability P is compared to a threshold that may be based, for example, on industry standards or design considerations. If the result of the threshold comparison indicates that the assumption is not correct, then a new set of correlations and probability calculations are produced using a subsequent symbol from the buffer. This process is repeated until the threshold is satisfied or a timeout condition is met.

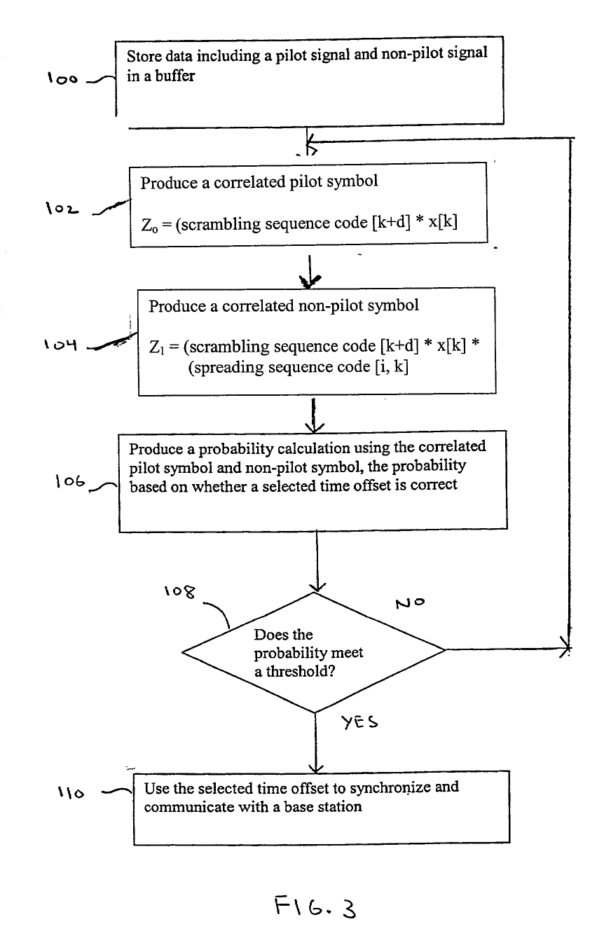

As shown in FIG. 3, the searcher receiver 20 stores 100 data containing a pilot signal and non-pilot signals into a buffer. The data in the buffer 30 can be organized into one or more groups of data samples such as a symbol containing 256 data samples.

Once the data is stored in the buffer 30, the pilot symbol correlator 32 produces 102 a correlated pilot symbol z₀,

where z₀=Σₖ(scrambling-sequence[k+d]*x[k]).

The scrambling-sequence [k+d] represents the [k+d] element from the scrambling sequence array. The term x[k] represents the k's element of the signal-samples data array {x[k]} retrieved from the buffer. The data array can be a complex number similar to the scrambling sequence elements. The index d represents a selected time offset which is examined or probed by the searcher. The pilot symbol correlator 32 retrieves a sample x[k] from the buffer 30. Each sample, x[k], from the data array is multiplied by a corresponding (k+d)-element,(in contemporary networks it is ±1 ±j) of the scrambling sequence. The multiplication results are accumulated to produce a correlated pilot symbol z₀.

The searcher receiver 20 then produces 104 a correlated non-pilot symbol such as z₁,

where z₁=Σ(scrambling sequence-code[k+d]*x[k]*spreading sequence-code[i, k]) and where the scrambling sequence-code[k+d] represents an array of scrambling sequence term x[k] represents the kth entry from the symbol data array retrieved from the buffer, and the index d represents the selected time offset used for the expected time offset associated with the pilot signal. However, in this calculation, a spreading sequence-code array is used and is indexed by a particular traffic channel index i. There can be a separate spreading sequence-code array for each traffic channel i in the system. The spreading sequence correlator 36 retrieves a symbol x[k] from the buffer 30. Each sample k in the symbol x[k] is multiplied by each element in the scrambling sequence code [k+d] to produce an intermediate result. Each intermediate result is then multiplied by each spreading sequence-code [i+k] to produce a final product. Each final product is accumulated to produce a correlated pilot symbol z₁. This process is performed by each non-pilot symbol correlator 36 to produce scrambling sequence symbols z₁ to zₙ.

The probability engine 40 then produces 106 a probability P by using the correlated pilot symbol Z0 and the correlated non-pilot symbols z₁ to zₙ. The probability P is based on the assumption that the selected time offset d that was chosen during the correlation process approximates a time offset associated with the pilot signal that was received by the mobile station. The probability calculation includes conditional probability arithmetic.

In one embodiment the input of the probability engine of the mobile-searcher at a given iteration (sometimes called a dwell) is an array of correlated symbols

z=(z₀,z₁, . . . ,zₙ)

where z₀ represents a pilot channel sum of a few symbols.

The probability of the hypothesis that a selected time offset d that was chosen during the correlation process approximates the actual time offset between the mobile station and the base station. This probability is an estimate and is conditioned on the input data of correlated symbols z=(z₀,z₁, . . . ,zₙ).

The probability engine 40 operates according to the following model. It is presumed that in the case of an incorrect hypothesis z₀,z₁, . . . ,zₙ are independent zero mean complex gaussian random variables (r.v.) representing noise with σ²ᵢ-variance for the real and imaginary parts of zᵢ. In the case of a correct hypothesis the channel and transmitted bits may be present in the received data. In this case—of a correct hypothesis—a complex zero mean gaussian r.v, h, representing the channel (multiplied by a constant) is added. In this scenerio, the procedure involves n+2 independent zero mean complex gaussian r.v. h, N₀,N₁, . . . Nₙ and the symbols are given by:

zᵢ=tᵢ·sᵢh+Nᵢ

where sᵢ is complex data bit from the set U=def={1,−1,j,−j} and:

tᵢ=2*·(the proportion of energy dedicated the channel)^{1/2}(length of the symbol).

The variance for the real and imaginary parts of h is denoted by σₙ₊₁²=σ².

It is given that s₀=1 (as no data is sent over the pilot channel) and it that for n≧i>0 sᵢ is chosen randomly with uniform distribution from the set U and is independent of all other sⱼ, j_{≠}i. The set of all configuration of bits is denoted by:

V=V(n)={s=(1,s₁, . . . ,sₙ):s₁, . . . ,sₙεU}.

In general there is a known probability function P that assigns a value to each configuration

s=(1, s₁, . . . , sₙ), of bits,

where s₁, . . . , sₙεU, denoted by P(s). The uniform distribution is a special case in which P(s)=4⁻ⁿ, for all s=(1, s₁, . . . , sₙ).

Let A be the event that the hypothesis under consideration is not correct and B=A^{c} that it is correct. Then the probability of A (and of B) conditioned on the given observations, that is the correlated symbols z=(z₀, z₁, . . . , zₙ)) is given by:

P(A|z)=(1+(p(z|B)/p(z|A))·((P(A)⁻¹−1))⁻¹

P(B|z)=1−P(A|z).

What is required is a term written as function of the observation vector z. This is accomplished in the next step where such term is given for p(z|B)/p(z|A), which is then carried over to P(A|z). The function is expanded into a few expressions for ease of discussion. (It is proved by integration on the channel.)

Let P be the distribution on the set of all (transmitted) n-symbols, V, and define for

$$\begin{matrix}c = {\sum }_{0 \leq i \leq n + 1} {t}_{1}^{2} / ( 2 {σ}_{i}^{2} ) , \\ \begin{matrix}{v}_{i} = {z}_{i} {t}_{i} / ( 2 \cdot {c}^{1 / 2} \cdot {σ}_{i}^{2} ) , & i = 0 , 1 , … , n , & v = ( {v}_{0} , … , {v}_{n} ) :\end{matrix} \\ \begin{matrix} & & {g}_{P , n} ( v ) = def = {\sum }_{s ∈ V ( n )} P ( s ) \cdot exp ( {\vert ( v , s ) \vert}^{2} ) . \\ Then & & \\ & & p ( z \vert B ) / p ( z \vert A ) = {c}^{- 1} \cdot {σ}^{- 2} {g}_{P , n} ( v ) .\end{matrix}\end{matrix}$$

Here, in accordance with common convention, the complex conjugate of a complex number w=x+j·y is denoted here by the standard w*=x−j·y and (s,v) stands for the standard inner product, that is:

(v,s)=Σᵢvᵢ·sᵢ*, in addition |v|²=(v,v).

The complex scalars v₀, . . . ,vₙ are considered normalized correlated symbols. In practice, the distribution of bits may be uniform, P(s)=4⁻ⁿ for all configuration of bits, s. In such a case gₙ(v)=g_{P,n}(v). The size of the sum in the expression for term gₙ(v) is exponential 4ⁿ, hence it can be directly and accurately computed with a small computational load only for a rather small number of unknown bits, n. For larger n, approximations of gₙ(v) by low complexity algorithms may be used. These approximations are discussed in detail below. The proceeding discussion describes approximations to gₙ(v) or, equivalently, to p(z|B)/p(z|A) and mentions, whenever applicable, if this is an upper bound or lower bound, as these are properties that can be employed for further enhancements.

Some of the approximating methods of the function gₙ(v), may require the use of the following norm defined here on complex linear spaces. For v=(v₀, . . . ,vₙ)εCⁿ⁺¹ define the norm:

$$[ v ] = max \{ \vert {\sum }_{0 \leq i \leq n} {V}_{i} \cdot {S}_{1}^{*} \vert : ( {S}_{0} , … , {S}_{n} ) ∈ {U}^{n + 1} \} .$$

This norm is called here the MBR (Max-Bit-Reconstruction) norm. An efficient method of computing this norm is described below.

In an embodiment, the following procedure can be used to compute the MBR norm (called here the MBR procedure) as part of the probability engine that estimates gₙ(v). The input of this procedure is an n-dimensional complex array v=(v₁, . . . ,vₙ), where each complex number is given in Cartesian coordinates, zᵢ=xᵢ+j·yᵢ, and the output is the MBR norm [v].

step 1: For each i=1,2, . . . ,n, separately, the procedure finds the unique uᵢ in U={1,−1,j,−j} such that

Re(uᵢ*·zᵢ)>0 & Im(uᵢ*·zᵢ)≧0, and insert v′ᵢ=vᵢ·uᵢ*.

The complexity of this step includes 2n real comparisons with 0.

step 2: The procedure finds a permutation πεSₙ that satisfies:

y′_{π(1)}/x′_{π(1)}≦y′_{π(2)}/x′_{π(2)}≦ . . . ≦y′_{π(n)}/x′_{π(n)},

and for each i=1,2, . . . ,n inserts: zᵢ< - - - z′_{π(i)}

The complexity of this step includes n real divisions, n·log(n) comparisons, n real insertions.

step 3: The procedure computes: h₀=(−j)·Σ_{1≦p≦n}z′ₚ and inserts Max=|h₀|².

The complexity of this step includes 2·n real additions.

step 4: for i=1 to n do

hᵢ=hᵢ₋₁+(1+j)·z′ᵢ

if (|hᵢ|²>Max): Max=|wᵢ|²

The complexity of this step includes 5·n real additions, 2n real products.

The procedure returns the value: [z]=Max^{1/2}.

In another embodiment, the upper-bound approximation of gₙ(v), called here Upper-Bound 1 (UB1) is based on the following mathematical inequality:

g_{u1,n}(v)=def=(exp(|[v]|²)≧gₙ(v₀, . . . ,vₙ).

The following steps of implementing this inequality can be used:

Step 1: Compute [v] by the MBR code as described above.

Step 2: Compute (exp(|[v]|²) using a look up table for the exponent.

Also, in some embodiments, the following lower-bound approximation of gₙ(v), called here Lower-Bound 1 (LB1) is computed. It is based on the following mathematical inequality, for v=(v₀, . . . ,vₙ):

gₙ(v)≧exp(|v|²)=def=g_{L1,n}(v).

The following steps of implementing this approximation may be used:

Step 1: Compute |v|² in a straightforward standard fashion.

Step 2: Compute (exp(|v|²) using a look up table for the exponent.

Further, in another embodiment, the following upper-bound approximation of gₙ(v), called here Upper-Bound 2 (UB2) is computed. It is based on the following mathematical inequality, Let α=def=(8^{1/2}−2)/2 then:

$$\begin{matrix}{g}_{u2} ( v ) = def \\ = {4}^{- n} {π}_{0 \leq i \leq n} ( {\sum }_{{s}_{i} ∈ U} exp ( [ v ] \cdot ( Re ( {v}_{i} \cdot {s}_{i}^{*} ) α \cdot Im ( {v}_{i} \cdot {s}_{i}^{*} ) ) ) + \\ {4}^{- n} {π}_{0 \leq i \leq n} ( {\sum }_{{s}_{i} ∈ U} exp ( [ v ] \cdot ( Re ( {v}_{i} \cdot {s}_{i}^{*} ) - α \cdot Im ( {v}_{i} \cdot {s}_{i}^{*} ) ) ) \\ \geq {g}_{n} ( {v}_{0} , … , {v}_{n} )\end{matrix}$$

The following pseudo-code that implements this approximation may be used:

r = [V];
a = (sqrt(8) - 2) /2
product1=1;
product2=1;
for (i=0 ; i <= n ; i++)
{

u[0]= r*(Re_V[i] + a*Im_V[i]);

/*s=1*/

u[1]= −u[0];

/*s=−1*/

u[2]= r*(−Im_V[i] + a*Re_V[i]);

/*s=−j */

u[3]= u−[2];

/*s=−j*/

v[0]= r*(Re_V[i] − a*Im_V[i]);
v[1]= −v[0];
v[2]= r*(−Im_V[i] − a*Re_V[i]);
v[3]= −v[2];
U=0;
V=0;
for (k=0 ; k < 4 ; k++)
{

U = U + exp (u [k]);
V = V + exp (v [k]);

}
product1=product1*U/4;
product2=product2*V/4;

}

return x=4*(product1+product2).

The function gₙ(v) may be estimated by using the following mathematical approximating inequality, possibly in conjecture with the MBR procedure:

Let v=(v₀, . . . ,vₙ)εCⁿ⁺¹ and 0<k≦n. Put u=(v₀+v₁+ . . . +vₖ₋₁)/k

It then holds for y=(u,u . . . (k times) . . . u,vₖ, . . . ,vₙ) that:

gₙ(v₀, . . . ,vₙ)≧gₙ(u,u . . . u,vₖ, . . . ,vₙ).

This inequality may be determined by calculating the function g_{L2,n}(v), which is an lower bound of gₙ(v), defined and produced as follows:

1. Let v=(v₀, . . . ,vₙ) be an array of normalized correlated symbols and let s=(s₀, . . . ,sₙ)εUⁿ⁺¹ satisfy:

$$[ v ] = \vert {\sum }_{0 \leq i \leq n} {V}_{i} \cdot {S}_{1}^{*} \vert$$

where [v] stands for the MBR norm, U={1,−1,j,−j}, and finding [v] and s may be done with the MBR procedure.

Define further:

2. w′ᵢ=vᵢ·sᵢ*for 0≦i≦n,

3. u′=(w′₁+w′₂+ . . . +w′ₙ)/n,

4. y=u′*/|u′|,

5. w₀=y·w′₀,

6. u=y·u′,

7. x₀=Re(w₀),

8. y₀=Im(w₀),

9. y=(w₀,u,u, . . . ,u),

and finally define:

g_{L2,n}(v)=gₙ(y).

The following method can be used to calculate g_{L2,n}(v):

Step 1: Compute the equalities 1-9 of the definition above.

Step 2: For each −n≦p≦n the processor computes (possibly by applying a lookup table) and stores in memory the following arrays a[ ] & b[ ]:

a[p]=exp ((x₀+u·p)²), b[p]=exp ((y₀+u·p)²),

Step 3: Computation of the desired output by the use of the following identity:

$$\begin{matrix}{g}_{n} ( y ) = {4}^{- n} {\sum }_{0 \leq m \leq n} ( \begin{matrix}n \\ m\end{matrix} ) ( {\sum }_{0 \leq k \leq m} ( \begin{matrix}m \\ k\end{matrix} ) a [ 2 k - m ] ) \cdot \\ ( {\sum }_{0 \leq i \leq n - m} ( \begin{matrix}n - m \\ i\end{matrix} ) b [ m + 2 i - n ] )\end{matrix}$$

The complexity of step 1 includes about n·log(n) arithmetic operations. The complexity of step 2 includes requires 4n+2 exponents (performed using a lookup table), products and addition operations. The complexity of step 3, which may be performed using a look-up table, includes n²+2n products and addition operations, and the same number of references to a binomial look-up table.

In addition, the channel h can be estimated through generalized likelihood ratio test (GLRT) or through other estimators. It may then use the following term for the probability, or an equivalent term,

$$\begin{matrix} & \begin{matrix}p ( z \vert B ) / p ( z \vert A ) = exp ( - C \cdot {\vert h \vert}^{2} ) \cdot \\ {π}_{0 \leq i \leq n} ( \frac{1}{4} {\sum }_{{s}_{i} ∈ U} exp ( Re ( {z}_{i}^{*} \cdot {t}_{i} \cdot {s}_{i} \cdot h ) / {σ}_{i}^{2} ) )\end{matrix} \\ where : & \\ & C = {\sum }_{0 \leq i \leq n} {t}_{i}^{2} / ( 2 {σ}_{i}^{2} ) .\end{matrix}$$

In another embodiment, the natural log of this equation can be calculated and compared to the result with appropriate thresholds. Consequently we have:

$$\begin{matrix}log ( p ( z \vert B ) / p ( z \vert A ) ) = - C \cdot {\vert h \vert}^{2} + \\ {\sum }_{0 \leq i \leq n} log ( \frac{1}{4} {\sum }_{s ∈ U} exp ( Re ( {z}_{i} \cdot {t}_{i} \cdot {s}^{*} \cdot {h}^{*} ) / {σ}_{i}^{2} ) )\end{matrix}$$

The computed probability for the incorrectness of an hypothesis (based on the vector of observations Z) or alternatively one or few approximations of this probability are checked in 108 to determine whether one or more predetermined thresholds are met. For example, the probability can be compared to a miss-detect threshold and a false-alarm threshold. The false-alarm threshold represents the likelihood that the selected time offset hypothesis is correct when, in fact, it is not. On the other hand, the miss-detect threshold represents the likelihood that the current selected time offset hypothesis is wrong when it is actually correct.

If the probability P is less than the false-alarm threshold, then the assumption based on the selected time offset is correct and the selected time offset can be used 110 to synchronize and communicate with a base station. As discussed above, the assumption is based on the probability that the selected time offset approximates the time offset associated with the pilot signal.

On the other hand, if the probability is greater than the miss-detect threshold, then the assumption based on the selected time offset is considered incorrect. The foregoing process can be repeated using a new time offset d and the next symbol from the buffer 30. The new time offset is used during the next correlation and probability/hypothesis calculation.

Similarly, if the probability is greater than the false-alarm threshold, but less than the miss-detect threshold, then the above process is repeated. A subsequent symbol from the buffer is used, and a new correlation pilot symbol and non-pilot symbol are calculated to produce a new probability. The new probability is compared to threshold(s). When the process is repeated, a new time offset d is selected and used to evaluate the actual time offset present in the pilot signal that is transmitted from the base station. In addition, if the number of symbols has been exhausted during the process without successfully finding a correct time offset, then the process is performed using a new symbol. During each correlation calculation, the correlations results are constantly accumulated for use in the next probability calculation. The process above is repeated and any previously accumulated results are discarded when the time offset d has been exhausted. In a similar manner, when the symbols in the buffer have been processed, the above process is repeated.

Using the foregoing techniques, the overall process of synchronizing a mobile station with a base station can be improved. The time required to synchronize can be reduced because non-pilot signal data, as well as pilot signal data, is used to extract synchronization. The use of non-pilot data can provide additional information for synchronization. As a result, the number of samples, the computational calculations, and the time needed to synchronize can be reduced.

Various features of the invention can be implemented in hardware, software, or a combination of hardware and software. For example, some aspects of the system can be implemented in computer programs executing on programmable computers. Each program can be implemented in a high level procedural or object-oriented programming language to communicate with a computer system. Furthermore, each such computer program can be stored on a storage medium, such as read-only-memory (ROM) readable by a general or special purpose programmable computer or processor, for configuring and operating the computer when the storage medium is read by the computer to perform the functions described above.

Other implementations are within the scope of the following claims.

What is claimed is:

1. A method comprising:
processing at least one non-pilot channel; and
determining whether a base station is synchronized based on results of processing.

2. The method of claim 1 wherein processing the non-pilot channel includes producing at least one non-pilot correlated symbol by correlating a signal sequence with a spreading sequence that corresponds to the non-pilot channel.

3. The method of claim 2 wherein producing the at least one non-pilot correlated symbol includes processing signals that have been previously stored in a memory.

4. The method of claim 1 wherein determining synchronization includes computing a correlated symbol and comparing the correlated symbol with a predetermined threshold.

5. The method of claim 1 further comprising processing a pilot signal that includes producing a correlated pilot symbol by correlating a signal sequence with a network scrambling sequence.

6. The method of claim 1 wherein determining synchronization includes computing a probability based on correlated pilot symbols and non-pilot symbols and checking whether the probability satisfies a threshold.

7. The method of claim 6 wherein the threshold includes at least one miss-detect threshold and one false-alarm threshold.

8. The method of claim 1 wherein the non-pilot channel include a traffic channel or a control channel.

9. The method of claim 1 further comprising producing pilot symbols using correlations of a sampled signal sequence and a network scrambling sequence.

10. A searcher receiver comprising:
a buffer for storing data; and
a processor coupled to the buffer, the processor including a computer-readable medium storing instructions that when applied to the processor, cause the processor to:
process at least one non-pilot channel, and
determine whether a base station is synchronized based on results of processing.

11. The searcher receiver of claim 10 wherein the processor is configured to produce at least one non-pilot correlated symbol by correlating a signal sequence with a spreading sequence that corresponds to the non-pilot channel.

12. The searcher receiver of claim 11 wherein the processor is configured to produce the at least one non-pilot correlated symbol by processing signals that have been previously stored in a memory.

13. The searcher receiver of claim 10 wherein the processor is configured to determine synchronization by computing a correlated symbol and comparing the correlated symbol with a predetermined threshold.

14. The searcher receiver of claim 10 wherein the processor is configured to process a pilot signal that includes producing a correlated pilot symbol by correlating a signal sequence with a network scrambling sequence.

15. The searcher receiver of claim 10 wherein the processor is configured to determine synchronization includes computing a probability based on correlated pilot symbols and non-pilot symbols and checking whether the probability satisfies a threshold.

16. The searcher receiver of claim 15 wherein the threshold includes at least one miss-detect threshold and one false-alarm threshold.

17. The searcher receiver of claim 10 wherein the processor is configured to produce pilot symbols using correlations of a sampled signal sequence and a network scrambling sequence.

18. A mobile station comprising:
a front-end circuit to convert electrical signals into digital data; and
a searcher receiver coupled to the front-end circuit to receive the digital data, wherein the searcher receiver comprising:
a buffer storing data, and
a processor coupled to the buffer, the processor including a computer-readable medium storing instructions that when applied to the processor, cause the processor to:
process at least one non-pilot channel, and
determine whether a base station is synchronized based on results of processing.

19. The mobile station of claim 19 wherein the processor is configured to process the non-pilot channel includes producing at least one non-pilot correlated-symbol by correlating a signal sequence with a spreading sequence that corresponds to the non-pilot channel.

20. The mobile station of claim 19 wherein the processor is configured to produce the at least one non-pilot correlated symbol includes processing signals that have been previously stored in a memory.

21. The mobile station of claim 19 wherein the processor is configured to determine synchronization includes computing a correlated symbol and comparing the correlated symbol with a predetermined threshold.

22. The mobile station of claim 19 wherein the processor is configured to process a pilot signal that includes producing a correlated pilot symbol by correlating a signal sequence with a network scrambling sequence.

23. The mobile station of claim 19 wherein the processor is configured to determine synchronization includes computing a probability based on correlated pilot symbols and non-pilot symbols and checking whether the probability satisfies a threshold.

24. The mobile station of claim 19 wherein the processor is configured to produce pilot symbols using correlations of a sampled signal sequence and a network scrambling sequence.

25. A communications system comprising:
a base station configured to send electrical signals; and
a mobile station electrically coupled to the base station, the mobile station including a front-end circuit to convert the electrical signals into digital data and a searcher receiver coupled to the front-end circuit to receive the digital data, wherein the searcher receiver comprising:
a buffer for storing data, and
a processor coupled to the buffer, the processor including a computer-readable medium storing instructions that when applied to the processor, cause the processor to:
process at least one non-pilot channel, and
determine whether a base station is synchronized based on results of processing.

26. The communications system of claim 25 wherein the processor is configured to processing the non-pilot channel includes producing at least one non-pilot correlated symbol by correlating a signal sequence with a spreading sequence that corresponds to the non-pilot channel.

27. The communications system of claim 26 wherein the processor is configured to producing the at least one non-pilot correlated symbol includes processing signals that have been previously stored in a memory.

28. The communications system of claim 25 wherein the processor is configured to determine synchronization that includes computing a correlated symbol and comparing the correlated symbol with a predetermined threshold.

29. The communications system of claim 25 wherein the processor is configured to process a pilot signal that includes producing a correlated pilot symbol by correlating a signal sequence with a network scrambling sequence.

30. The communications system of claim 25 wherein the processor is configured to determine synchronization that includes computing a probability based on correlated pilot symbols and non-pilot symbols and checking whether the probability satisfies a threshold.
